(19) United States
(12) Patent Application Publication
(10) Pub. No.: US 2016/0379529 A1
(43) Pub. Date: Dec. 29, 2016

(54) LABEL AND METHOD FOR PRODUCING SAME

(71) Applicant: Sato Holdings Kabushiki Kaisha, Tokyo (JP)

(72) Inventors: Hiromi YAMAMURO, Tokyo (JP); Yoshihito FUJII, Tokyo (JP)

(21) Appl. No.: 15/262,285

(22) Filed: Sep. 12, 2016

Related U.S. Application Data
(62) Division of application No. 13/877,928, filed on Apr. 5, 2013.

(30) Foreign Application Priority Data
Oct. 22, 2010 (JP) 2010-237694

(51) Int. Cl. G09F 3/10; C09J 7/02

(52) U.S. Cl. CPC G09F 3/10; C09J 7/02; G09F 2003/025

(57) ABSTRACT

A label and a label manufacturing method for securely curing an adhesive. The label includes a substrate sheet 11, an adhesive layer 12 formed on the substrate sheet 11, and a cured layer 13 formed on part of the adhesive layer 12, in which the cured layer 13 is formed by curing an acrylic-base bonding adhesive. Manufacturing includes applying an adhesive on the substrate sheet 11 to form the adhesive layer 12, applying the bonding adhesive on the adhesive layer 12, and forming a cured layer by irradiating the adhesive layer 12 and the bonding adhesive with an active energy ray to cure the adhesive layer 12 and the bonding adhesive.

### CROSS-REFERENCE TO RELATED APPLICATIONS

The present application is a divisional of U.S. patent application Ser. No. 13/877,928, filed Apr. 5, 2013, which is a 35 U.S.C. §371 national phase conversion of PCT/JP2011/002529, filed May 2, 2011, which in turn claims priority of Japanese Patent Application No. 2010-237694, filed Oct. 22, 2010, the contents of which are incorporated by reference herein. The PCT International Application was published in the Japanese language.

### TECHNICAL FIELD

The present invention relates to a label and a manufacturing method of the label.

### BACKGROUND ART

Known conventional label sheets in which a fore end edge of resin labels are cured by coating application or printing so that the labels are securely separated from their release papers by a label dispenser (for example, Japanese Patent Application Laid-Open No. 09-19797).

However, it is difficult to completely cure an adhesive by coating application or printing, and labels sometimes cannot be separated from release paper if a label dispenser is used. To counter this problem, a technique that more securely cures the adhesive is desired.

### SUMMARY OF INVENTION cl Technical Problem

An object of the present invention is to provide a label and a manufacturing method of the label capable of more securely curing an adhesive.

### Solution to Problem

The present invention solves the problem above by employing the following solutions:
(1) A label including: a substrate sheet; an adhesive layer formed on the substrate sheet; and a cured layer formed on a part of the adhesive layer, wherein the cured layer is formed by curing an acrylic-base bonding adhesive.
(2) The label set forth in (1), in which the cured layer is cured integrally with the part of the adhesive layer under the cured layer.
(3) The label set forth in (1), in which the acrylic-base bonding adhesive is a radical polymerizable ultraviolet curable composition.
(4) The label set forth in (1), in which the cured layer has a thickness of 40 μm or more and 60 μm or less.
(5) The label set forth in (1), in which the cured layer is formed on an entire circumference of the adhesive layer.
(6) The label set forth in (1), in which the adhesive layer is a rubber-base adhesive.
(7) The label set forth in (1), in which the adhesive layer has a thickness of 40 μm or more and 60 μm or less.
(8) A method of manufacturing a label including: a step of applying an adhesive on a substrate sheet to form an adhesive layer; applying a bonding adhesive on the adhesive layer; curing by irradiating the adhesive layer and the bonding adhesive with an active energy ray to cure the adhesive layer and the bonding adhesive.

### Advantageous Effects of Invention

According to the present invention, it is possible to provide a label and a manufacturing method of the label capable of enhancing the secure curing of an adhesive.

It is possible to cure a rubber-base adhesive that has been difficult to cure by coating application or printing.

It is also possible to provide a label and a manufacturing method of the label capable of preventing an adhesive from exuding from a cut surface of the label.

Particularly in a label for a tire, it is possible to stick the label onto a tire with an automatic labeling apparatus.

### BRIEF DESCRIPTION OF DRAWINGS

FIG. 1 illustrates a label according to a first embodiment, in which (A) is a plan view of the label and (B) is a side view of the label.

FIG. 2 illustrates a label according to a second embodiment, in which (A) is a plan view of the label and (B) is a side view of the label.

FIG. 3 illustrates a label according to a third embodiment, in which (A) is a plan view of the label and (B) is a side view of the label.

FIG. 4 is a flow chart showing a manufacturing method according to the present invention.

### DESCRIPTION OF EMBODIMENTS

Hereinafter, description will be provided on the embodiments of the present invention with reference to the drawings.

A label of the present invention includes a substrate sheet, an adhesive layer formed on the substrate sheet, and a cured layer formed on a part of the adhesive layer. The cured layer is formed by curing an acrylic-base bonding adhesive.

### First Embodiment

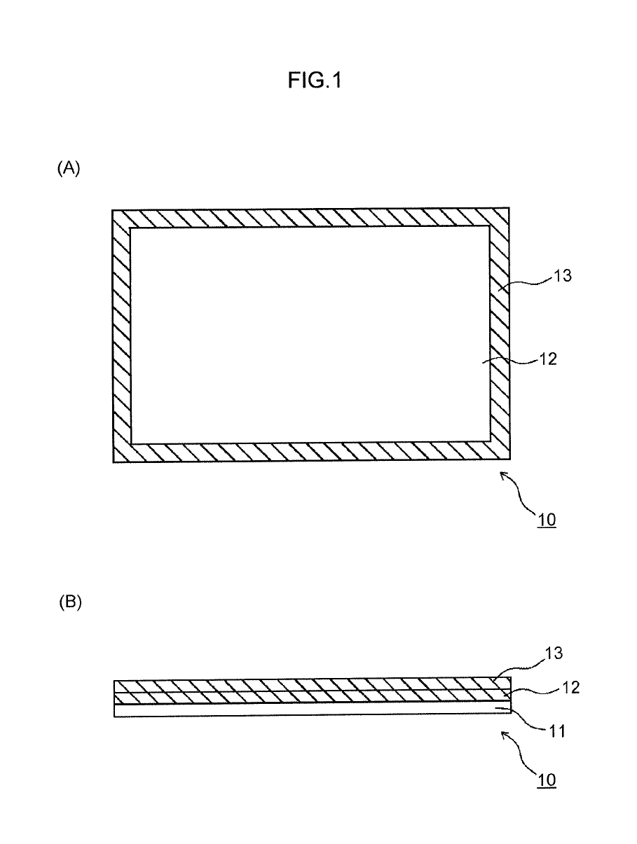

FIG. 1 illustrates a label according to a first embodiment, in which (A) is a plan view of the label and (B) is a side view of the label.

A label 10 according to the first embodiment includes a substrate sheet 11, an adhesive layer 12, and a cured layer 13.

The substrate sheet 11 may be made of: a paper such as fine a quality paper, coated paper and art paper; a film made of a polyolefin resin such as polyethylene and polypropylene, a polyester (polyethylene-telephthalate) resin, a polycarbonate resin, and a vinyl chloride resin such as polyvinyl chloride, and chlorinated polyvinyl chloride made by combining polyvinyl chloride with chlorine; a synthetic paper manufactured by adding filling material to polyethylene or polypropylene to have a paper-like fibrous form; and a laminated body or a composite body made of the above and similar.

The substrate sheet 11 may be laminated.

In general, a brand name, a manufacture's name, a size, type and oblateness of a tire, and data indicating the above information in a bar code symbol and the like may be printed on the substrate sheet 11.

The adhesive forming the adhesive layer 12 is not limited, and examples of the adhesive may include an emulsion-type, a solvent-type or a hot-melt type adhesive. Any material such as an acrylic-base material or a rubber-base material may be used. The adhesion characteristics may be selected based on the type of an object on which the label is stuck. For example, the adhesion characteristics may include high adhesion, ultra-high adhesion having further stronger tackiness, or a freezer-grade adhesion if there is no need to remove the label once it is stuck on the object. A rubber-base adhesive which is compatible with a tire is preferably used on a label for being stuck on a tire.

The adhesive layer 12 preferably has a thickness of 10 μm or more and 60 μm or less. In a label for being stuck on a tire, the adhesive layer 12 preferably has a thickness of 40 μm or more and 60 μm or less.

The cured layer 13 is formed by curing an acrylic-base bonding adhesive.

The acrylic-base bonding adhesive used in the present invention preferably includes an active energy ray curable composition containing (meth) acrylate as a main component. The active energy ray may be an electron ray, a visible light ray, or an ultraviolet ray. The acrylic-base bonding adhesive may include an acrylic-base additive agent such as a photoinitiator, a polymerization inhibitor, a thickener, a plasticizer, and a coloring agent. The acrylic-base bonding adhesive used in the present invention preferably includes a radical polymerizable ultraviolet curable composition that is easy to use for the convenience of applying and curing the bonding adhesive on the adhesive layer. For example, it is preferable to use “ARONIX (registered trademark)” which is a brand name of Toagosei Co., Ltd.

The acrylic-base bonding adhesive is applied on the adhesive layer, and an ultraviolet ray or the like is irradiated onto this acrylic-base bonding adhesive, thereby curing the acrylic-base bonding adhesive as well as the underlying adhesive layer into the cured layer 13.

The cured layer 13 is formed on a part of the adhesive layer 12.

The cured layer 13 preferably has the same thickness as the adhesive layer 12.

Specifically, the thickness of the cured layer 13 is preferably 10 μm or more and 60 μm or less. If the label is the one for being stuck on a tire, the thickness of the cured layer 13 is preferably 40 μm or more and 60 μm or less.

A sufficient thickness of the cured layer 13 relative to the thickly-applied adhesive layer 12 enables securely separating the label from the backing sheet.

In the present invention, the bonding adhesive having strong adhesion is applied and then cured so as to form the cured layer, although a printing ink or a varnish is generally used for reducing the adhesive force.

The cured layer of the present invention includes a bonding adhesive and an adhesive which has already been cured. Consequently, since the adhesion of the adhesives is completely lost and the label is easily separated from the backing sheet, it is possible to stick the label onto a tire with an automatic labeling apparatus.

The cured layer 13 is preferably formed on the entire circumferential edge of the adhesive layer 12, as shown in FIG. 1. Since the cured layer 13 is formed on the entire circumferential edge of the adhesive layer 12, it is possible to separate the label 10 from a release sheet, described below, from any direction.

As shown in FIG. 1(B), it is preferable that the cured layer 13 and a part of the adhesive layer 12 are integrally cured. Integral curing of the cured layer 13 and the part of the adhesive layer 12 prevents exudation of the adhesive.

In addition, if the cured layer is formed on a cut surface of the label when the label is cut, it is possible to prevent exudation of the adhesive from the cut surface.

The label of the present invention may have an aluminum vapor deposited surface between the substrate sheet 11 and the adhesive layer 12. The aluminum vapor deposited surface blocks penetration of sulfur or the like from a tire into the substrate sheet 11, and enhances the protective performance of the label so as to prevent the deterioration of the label.

It is needless to say that application of the label is not limited to this, and the present invention is applicable to general label sheets.

The label of the present invention may include the release sheet separably laminated on the adhesive layer 12 and the cured layer 13.

A conventional sheet may be used for the release sheet. Examples of materials for the release sheet may include paper having a surface on which silicone is applied through a polyethylene coating, craft paper supercalendered after clay painting, glassine paper, a high quality separator, and various plastic films, etc.

### Second Embodiment

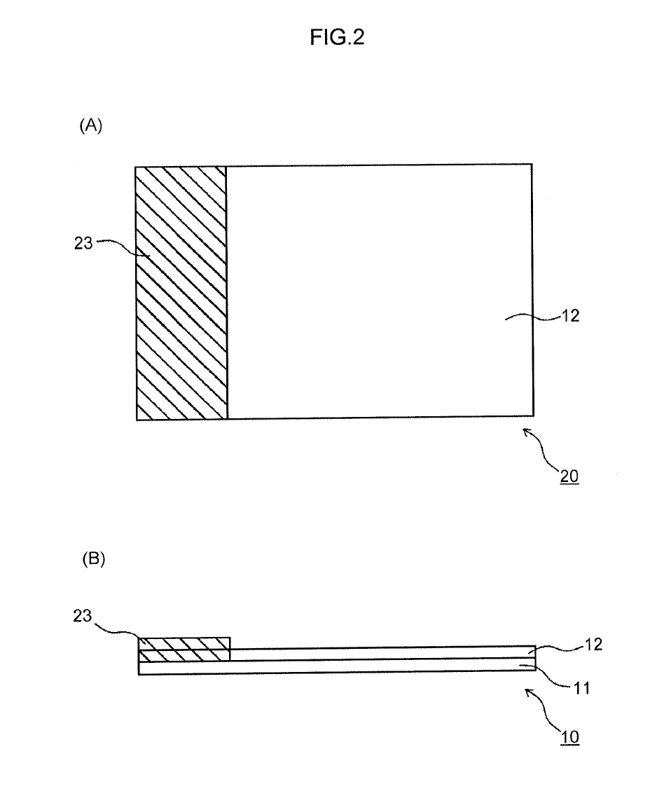

FIG. 2 shows a label according to a second embodiment, in which FIG. 2(A) is a plan view thereof and FIG. 2(B) is a side view thereof.

There is a label 20 of the second embodiment, a substrate sheet 11 and adhesive layer 12, and a cured layer 23.

The label 20 of the second embodiment is provided with the cured layer 23 formed on one side of the label.

The label can be easily separated from the backing sheet through the cured layer 23, which enables sticking the label onto a tire with an automatic labeling apparatus.

### Third Embodiment

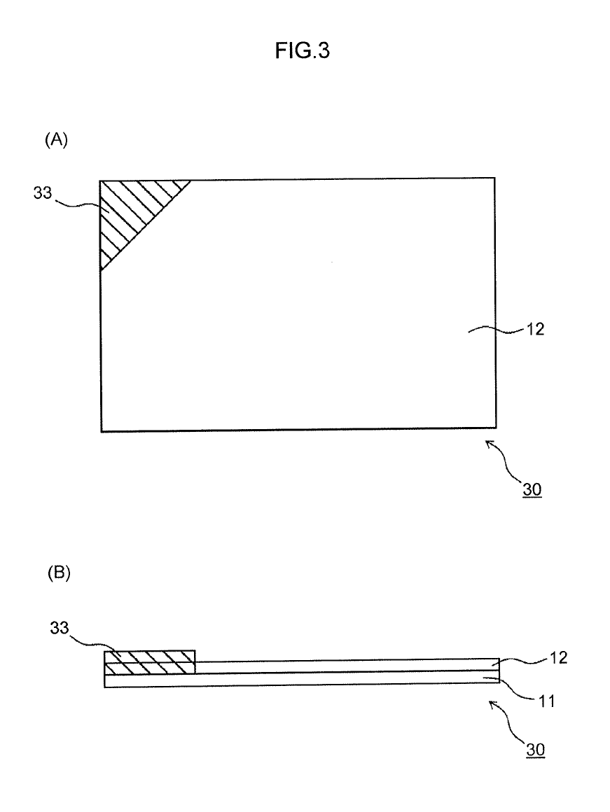

FIG. 3 shows a label according to a third embodiment, in which FIG. 3A is a plan view thereof, and FIG. 3(B) is a side view thereof.

The label 30 of the third embodiment includes a substrate sheet 11 an adhesive layer, and a cured layer 33.

The label 30 has the cured layer 33 formed at a corner of the label.

The label can be easily separated from the backing sheet due to the cured layer 33; thus it is possible to stick the label onto a tire with an automatic labeling apparatus.

### (Manufacturing Method)

The manufacturing method of the label according to the present invention includes a step of applying adhesive on the substrate sheet so as to form the adhesive layer, a step of applying the bonding adhesive on the adhesive layer, and a forming step of forming the cured layer by irradiating the adhesive layer and the bonding adhesive layer with an active energy ray to cure them.

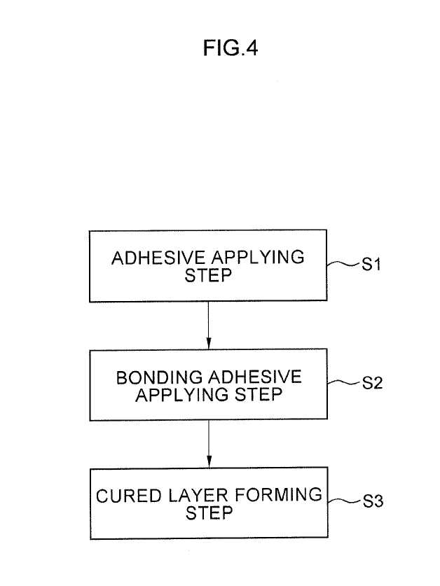

The method is described with reference to FIG. 4. FIG. 4 is a flowchart showing the manufacturing method of the label according to the present invention.

First, the substrate sheet is prepared.

In step S1, the adhesive is applied on the substrate sheet with a coating device, a color transferring device, a printer, a brush, a bar coater or the like, and is dried so as to form the adhesive layer (adhesive applying step).

In step S2, the bonding adhesive is applied on the adhesive layer with a color transferring device, a printer, or the like (bonding adhesive applying step).

In step S3, the adhesive layer and the bonding adhesive are irradiated with an active energy ray such as an ultraviolet ray or the like to cure the adhesive layer and the bonding adhesive (cured layer forming step).

### EXAMPLES

Hereinafter, Examples of the present invention are described.

The present inventors conducted the following test.

### Example 1

The substrate sheet (size: 85 mm×85 mm, thickness: 75 μm, brand name: “PET75k2424/PT3/8KA” manufactured by Lintech Corporation) was prepared.

The adhesive layer was formed by applying the adhesive (rubber-base adhesive, brand name: “PT3” manufactured by Lintech Corporation) on the substrate sheet with a commercially available coating device and drying the adhesive such that the adhesive layer has a thickness of 40 μm.

Then, a radical polymerizable bonding adhesive (brand name: “ARONIX LCR0239F” manufactured by Toagosei Co., Ltd.) mixed in a medium for flexography was applied on the entire circumferential edge of the adhesive layer with a commercially available color transferring device such that the bonding adhesive layer has a thickness of 40 μm and a width of 4 mm. This bonding adhesive layer was then irradiated with an ultraviolet ray to form the cured layer.

In the above described manner, the label of the Example 1 was manufactured.

### Example 2

A radical polymerizable bonding adhesive (brand name: “ARONIX LCR0239F” manufactured by Toagosei Co., Ltd.) mixed in a medium for use in flexography was applied onto one side of the adhesive layer with a commercially available color transferring device such that the bonding adhesive has a thickness of 40 μm and a width of 4 mm. The bonding adhesive was then irradiated with an ultraviolet ray to form the cured layer.

The label of the Example 2 was manufactured in the same condition as that of the Example 1 other than the above condition.

### Comparative Example 1

Varnish (brand name: “UP200” manufactured by T&K TOKA Corporation) was printed on the entire circumferential edge of the adhesive layer with a commercially available color transferring device such that the bonding adhesive layer has a thickness of 40 μm and a width of 4 mm, and thereafter the varnish was dried to form a low pressure-sensitive adhesion portion whose adhesion was reduced.

The label of the Comparative example 1 was manufactured in the same condition as that of the Example 1 other than the above condition.

Major conditions of the Examples and the Comparative example are shown in Table 1.

TABLE 1

| | Object applied on adhesive | |
|---|---|---|
| | layer | Cured layer |
| Example 1 | Acrylate-base bonding | Entire Circumference |
| | adhesive | |
| Example 2 | Acrylate-base bonding | One side |
| | adhesive | |
| Comparative | Printing ink | Entire Circumference |
| example 1 | | |

### (Evaluation)

### <Automatic Labeling Test>

In the Examples and in the Comparative example, 4200 labels were automatically stuck on commercially available tires in succession with a labeling device with a brand name “Tough arm” manufactured by Sato Holdings Corporation, It was confirmed whether or not a glue paddle was generated on an adsorption plate.
◯: No collected glue was generated on the adsorption plate.
×: Collected glue was generated on the adsorption plate.

### <Exudation of Adhesive>

The labels of the Examples and of the Comparative example were stuck on commercially available tires, and these tires were left for seven days under a circumstance having a temperature of 40° C. and a humidity of 80% RH.

A visual observation on the stuck state of each label was conducted to confirm whether or not the adhesive was exuded from the cut surface.
◯: No exudation occurs
×: Exudation occurs

TABLE 2

| | Automatic | Exudation of adhesive |
|---|---|---|
| | labeling test | from cut surface |
| Example 1 | ◯ | ◯ |
| Example 2 | ◯ | ◯ |
| Comparative example 1 | X | X |

As obvious in Table 2, the Example 1 and the Example 2 had preferable results regarding the automatic labeling test and the exudation of the adhesive from the cut surface.

To the contrary, the Comparative example 1 substantially had problems regarding the automatic labeling test and the exudation of the adhesive from the cut surface.

What is claimed is:

1. A method for manufacturing a label comprising:
applying an adhesive to form an adhesive layer on a substrate sheet;
applying an acrylic-base bonding adhesive on along a part of a circumferential edge area of the adhesive layer, the acrylic-base bonding adhesive including an active energy ray curable composition; and
irradiating the acrylic-base bonding adhesive with an active energy ray to cure the same.

2. The method as defined in claim 1, wherein the acrylic-base bonding adhesive is applied on an entire circumferential edge area of the adhesive layer.

3. The method as defined in claim 1, wherein the active energy ray curable composition is a radical polymerizable ultraviolet curable composition.

4. The method as defined in claim 1, wherein the active energy ray is an ultraviolet ray.

5. The method as defined in claim 1, wherein a boundary line between an area where the acrylic-base bonding adhesive is applied and an area where the acrylic-base bonding adhesive is not applied and the adhesive layer is exposed is a line connecting an intermediate part of a first side of the adhesive layer and an intermediate part of a second side of the adhesive layer.

6. The method as defined in claim 5, wherein the first side and the second side are opposite sides.

7. The method as defined in claim 5, wherein the first side and the second side are adjacent sides.
